(19) United States
(12) Patent Application Publication
(10) Pub. No.: US 2020/0400036 A1
(43) Pub. Date: Dec. 24, 2020

(54) GAS TURBINE ENGINE SYSTEM

(71) Applicant: PRATT & WHITNEY CANADA CORP., Longueuil (CA)

(72) Inventors: Timothy REDFORD, Campbellville (CA); David MENHEERE, Norval (CA)

(21) Appl. No.: 16/449,554

(22) Filed: Jun. 24, 2019

(51) Int. Cl. F01D 15/12; F02C 7/32; F02C 3/04; F01D 15/10; F16H 48/10

(52) U.S. Cl. CPC F01D 15/12; F02C 7/32; F02C 3/04; F01D 15/10; B64D 2013/0603; F05D 2260/40311; F05D 2220/32; F05D 2220/76; F16H 48/10

(57) ABSTRACT

A gas turbine engine system includes, in serial flow communication, an engine compressor configured to compress air, a combustor in which the compressed air is mixed with fuel and ignited to generate a stream of combustion gases, and a turbine configured to extract energy from the combustion gases. An electric generator is configured to be driven by the turbine and generate electric energy during use. An electric motor is configured to be driven by electric energy generated by the electric generator. The electric motor is configured in use to drive the engine compressor.

### FIELD

This relates to gas turbine engines and auxiliary power units.

### BACKGROUND

In a conventional auxiliary power unit (APU) (or Auxiliary Power System (APS)) including a gas turbine engine, a load compressor (LDC) provides an air flow to an environmental control system (ECS). As the LDC may be mechanically linked to an electric generator that is also driven by the gas turbine engine, the linked components are constrained to operating at a same operating speed. Therefore, at some operating conditions of the APU, the LDC may generate excessive compressed air that is not required by the ECS. Unused air may be dumped into an exhaust stream thereby wasting the energy used to compress the air.

### SUMMARY

According to an aspect, there is provided a gas turbine engine system, comprising: an engine compressor, a combustor, and a turbine in serial flow communication; an electric generator configured to be driven by the turbine; and an electric motor configured to be driven by electric energy generated by the electric generator, the electric motor configured in use to drive the engine compressor.

In some embodiments, the system comprises a differential gear train having an input drivingly coupled to the turbine and a first output, the electric generator being drivingly coupled to the first output of the differential gear train.

In some embodiments, the first output is drivingly coupled to a load compressor configured to generate compressed air for an environmental control system of an aircraft.

In some embodiments, the differential gear train has a second output that is drivingly coupled to the engine compressor.

In some embodiments, the engine compressor is a first engine compressor, and the system includes a second engine compressor operatively disposed downstream from the first engine compressor.

In some embodiments, the differential gear train includes an epicyclic gear set.

In some embodiments, the differential gear train includes a compound epicyclic gear set.

In some embodiments, the first output is drivingly coupled to a propeller.

According to another aspect, there is provided a method of operating a gas turbine engine, comprising: using an engine compressor to compress air; generating a stream of combustion gases by igniting the compressed air mixed with fuel; extracting energy from the combustion gases with a turbine; driving an electric generator with the turbine to generate electric energy; and driving the engine compressor using an electric motor driven by the electric energy generated by the electric generator.

In some embodiments, the method comprises driving the electric generator via a first output of a differential gear train.

In some embodiments, the method comprises driving the engine compressor via a second output of the differential gear train.

In some embodiments, the method comprises generating compressed air for an environmental control system of an aircraft using a load compressor driven via the first output of the differential gear train.

In some embodiments, the method comprises maintaining a substantially constant operating speed of the electric generator while varying an operating speed of the turbine.

In some embodiments, the method comprises maintaining a substantially constant operating speed of the load compressor while varying an operating speed of the turbine.

In some embodiments, the method comprises controlling the electric generator to maintain a desired operating speed of the load compressor.

In some embodiments, the method comprises maintaining a substantially constant operating speed of the electric generator while varying an operating speed of the turbine.

According to another aspect, there is provided an auxiliary power unit comprising: an engine compressor, a combustor, and a turbine in serial flow communication; a differential gear train having an input shaft drivingly coupled to the turbine, a first output shaft and a second output shaft, the differential gear train configured to apportion an input torque from the turbine between a first output torque applied to the first output shaft and a second output torque applied to the engine compressor via the second output shaft; an electric generator drivingly coupled to the first output shaft of the differential; and an electric motor configured to be driven by electric energy generated by the electric generator, the electric motor configured in use to drive the compressor.

In some embodiments, the auxiliary power unit further comprises a load compressor drivingly coupled to the first output shaft of the differential gear train.

In some embodiments, the engine compressor is a first engine compressor, and the auxiliary power unit includes a second engine compressor operatively disposed downstream from the first engine compressor.

In some embodiments, the differential gear train includes an epicyclic gear set.

Other features will become apparent from the drawings in conjunction with the following description.

### BRIEF DESCRIPTION OF DRAWINGS

In the figures which illustrate example embodiments,

FIG. 1 is a schematic cross-section view of an auxiliary power unit;

FIG. 2 is a schematic cross-section view of an auxiliary power unit in which components are connected through a differential gearbox, in accordance with an embodiment;

FIG. 3A is a schematic diagram of an epicyclic (differential) gear set in a first position, in accordance with an embodiment;

FIG. 3B is a schematic diagram of the epicyclic (differential) gear set of FIG. 3A in a second position;

FIG. 4 is a schematic diagram of a differential gearbox, in accordance with an embodiment;

FIG. 5 is a schematic cross-section view of an auxiliary power unit in which components are connected through a differential gearbox and an electric motor is connected to the generator and compressor shaft, in accordance with an embodiment;

FIG. 6 is a schematic cross-section view of an auxiliary power unit including a boost compressor and in which components are connected through a differential gearbox and an electric motor is connected to the generator and boost compressor shaft, in accordance with an embodiment;

FIG. 7 is a schematic diagram of an operating environment of the differential gearbox of the auxiliary power unit of FIG. 6, in accordance with an embodiment;

FIG. 8A is a schematic cross-section view of a turboprop engine, in accordance with an embodiment;

FIG. 8B is a schematic cross-section view of another turboprop engine, in accordance with an embodiment; and

FIG. 9 is a flow diagram of an example method for operating a gas turbine engine, in accordance with an embodiment.

### DETAILED DESCRIPTION

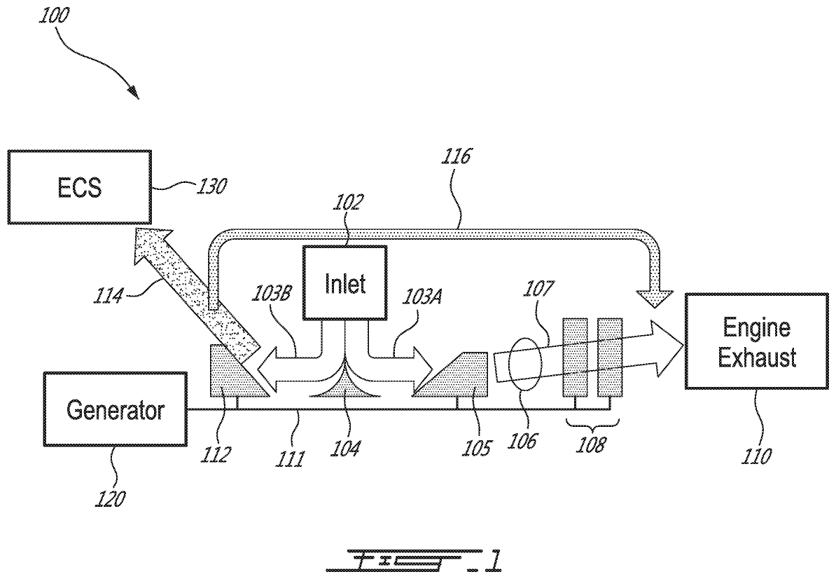

FIG. 1 illustrates an auxiliary power unit (APU) 100 (sometimes called “auxiliary power system”), an example of a gas turbine engine system, including a gas turbine engine for use on an aircraft to supply electric and pneumatic power to the aircraft systems as an auxiliary or secondary source of power. Another suitable engine may be employed.

As shown in FIG. 1, APU 100 includes an inlet 102 through which ambient air is drawn, a flow splitter 104 for splitting the inlet air into an engine stream air 103A and a load stream air 103B, a high pressure compressor (HPC) 105 for pressurizing the engine stream air 103A, a combustor 106 in which the compressed engine stream air 103A is mixed with fuel and ignited for generating an annular combustion stream 107 of hot combustion gases, and a turbine section 108 having turbines, for example, a two-stage turbine as shown in FIG. 1 or other multi-stage turbine, for extracting energy from the combustion gases which then exhaust to engine exhaust 110. The HPC 105, combustor 106 and turbine section 108 are in serial flow communication and form part of the gas turbine engine portion of the APU 100. The gas turbine engine defines a gas path through which gases flow, such as engine stream air 103A and combustion stream 107, to drive the engine. A power shaft 111 is connected to one or more turbines of turbine section 108 and HPC 105. Power shaft 111 is driven by the one or more turbines of turbine section 108.

APU 100 further includes a load compressor (LDC) 112 for pressurizing the load stream air 103B to generate load compressor air 114 for use by an environment control system (ECS) 130 of an aircraft in which APU 100 is installed. In some embodiments, for example, as shown in FIG. 1, LDC 112 may be linked mechanically to HPC 105 and turbine section 108 of the gas turbine engine by way of power shaft 111, and thus LDC 112 may be drivingly coupled to the gas turbine engine. APU 100 may also include a bypass excess air pathway or conduit establishing fluid communication between LDC 112 and the engine exhaust for directing at least some of excess load compressor air 116 to, in an example, an exhaust pathway to engine exhaust 110. Alternatively or in addition, the excess load compressor air 116 may be directed to another location upstream of one or more turbines of turbine section 108 in order to permit energy from the excess load compressor air 116 to be converted into useful work by the gas turbine engine of APU 100.

ECS 130 may provide air supply, thermal control, and cabin pressurization in the aircraft.

APU 100 may also be adapted to supply electric power to aircraft systems by way of a generator 120, an electric generator driven by turbine section 108 to generate electric energy during use. Generator 120 may be oil-cooled and include a gearbox for transferring power from power shaft 111 of APU 100 to electric power.

In some embodiments, generator 120 is a synchronous AC generator (sometimes referred to as an “alternator”), such as a permanent magnet generator.

In some embodiments, generator 120 may have a power rating of 120 kVA. In some embodiments, generator 120 generates AC current, for example, a three-phase, 400 Hz, 115 or 120 phase voltage output. In some embodiments, generator 120 may generate DC current.

In some embodiments, generator 120 operates at a substantially constant operating speed. In an example, generator 120 may operate at a constant speed of approximately 12,000 rpm (revolutions per minute), plus or minus 500 rpm.

In use, inlet 102 draws air into APU 100, and flow splitter 104 splits the inlet air into engine stream air 103A and load stream air 103B.

Engine stream air 103A is directed to HPC 105. HPC 105 pressurizes the air by rotating. In combustor 106, the compressed engine stream air 103A is mixed with fuel and ignited, generating combustion stream 107 of hot combustion gases. Propulsion of combustion stream 107 through turbine section 108 rotates the turbines of turbine section 108, thus extracting energy from the combustion gases, and rotating power shaft 111 that is drivingly coupled to one or more turbines in turbine section 108. Combustion stream 107 then exits APU 100 as engine exhaust 110.

Load stream air 1036 is directed to LDC 112. In embodiments in which LDC 112 is linked mechanically to HPC 105 and turbine section 108, for example, by way of power shaft 111, rotation of power shaft 111 drives the rotation of LDC 112.

The rotation of LDC 112 compresses air within LDC 112, generating compressed load compressor air 114. The compressed load compressor air 114 may then be directed to ECS 130 of the aircraft. As such, APU 100 is adapted to supply load compressor air 114 for pneumatic power to ECS 130.

Load compressor air 114 generated by LDC 112 may be regulated by inlet guide vanes and bleed valves (not shown). However, since the rotation of LDC 112 is mechanically linked to HPC 105, as HPC 105 rotates, so does LDC 112. In some embodiments, LDC 112 and HPC 105 rotate at the same speed. In some embodiments, LDC 112 and HPC 105 rotate at different speeds.

Thus, in embodiments in which LDC 112 is mechanically linked to HPC 105, any time HPC 105 rotates LDC 112 will generate load compressor air 114. As shown in FIG. 1, if more load compressor air 114 is generated by LDC 112 than is required by ECS 130, unused excess load compressor air 116 may be released by a bleed valve (not shown) and directed along an exhaust pathway to be injected into engine exhaust 110. As such, compressor work (generated by HPC 105 and LDC 112) may be wasted.

Rotation of power shaft 111 may also transfer power to the gearbox of generator 120 for electric power.

The sizing of APU 100 may be determined by the requirements at the highest commanded generator 120 power and/or ECS 130 pneumatic power, leaving APU 100 running below its maximum power at other points of the operating envelope.

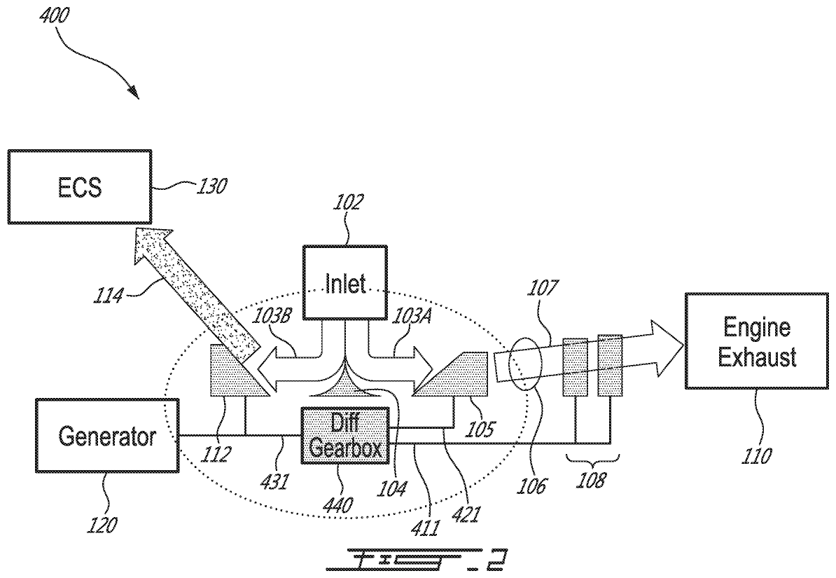

FIG. 2 illustrates an auxiliary power unit (APU) 400 including a gas turbine engine for use on an aircraft to supply electric and pneumatic power to the aircraft systems as an auxiliary or secondary source of power, in which components are connected through a differential gearbox. The differential gearbox can be configured to apportion an input torque between a first output torque and a second output torque.

Any other suitable engine may be employed.

As shown in FIG. 2, APU 400 includes some of the same structure and components as the architecture of APU 100, including inlet 102, flow splitter 104, engine stream air 103A, load stream air 103B, HPC 105, combustor 106, combustion stream 107, turbine section 108, engine exhaust 110, LDC 112, load compressor air 114, generator 120 and ECS 130, as described herein.

HPC 105, combustor 106 and turbine section 108, in serial flow communication, form part of the gas turbine engine portion of APU 400. The gas turbine engine defines a gas path through which gases flow, such as engine stream air 103A and combustion stream 107.

In place of a power shaft 111, APU 400 may include a turbine shaft 411, a compressor shaft 421 and a load shaft 431. Turbine shaft 411 connects to one or more turbines of turbine section 108. Compressor shaft 421 connects to HPC 105. Load shaft 431 connects to LDC 112 and generator 120.

Turbine shaft 411, compressor shaft 421 and load shaft 431 are connected to a differential gear train, such as a differential gearbox 440. Differential gearbox 440 may have one input, such as an input shaft, and a first output and a second output, such as two output shafts, each of which may be connected through a reduction gear set. In some embodiments, turbine shaft 411 may provide rotational input or torque to differential gearbox 440, and compressor shaft 421 and load shaft 431 may receive rotational output or torque from differential gearbox 440.

In some embodiments, differential gearbox 440 may include an epicyclic gear set, and in some embodiments, a compound epicyclic gear set. Differential gearbox 440 may contain one or more interconnected epicyclic (differential) gears, for example, epicyclic planetary gear set 500. Differential gearbox 440 may comprise three interconnected shafts, as described in further detail below. In some embodiments, differential gearbox 440 may be a fixed speed gearbox. In some embodiments, differential gearbox 440 may be a variable speed gearbox.

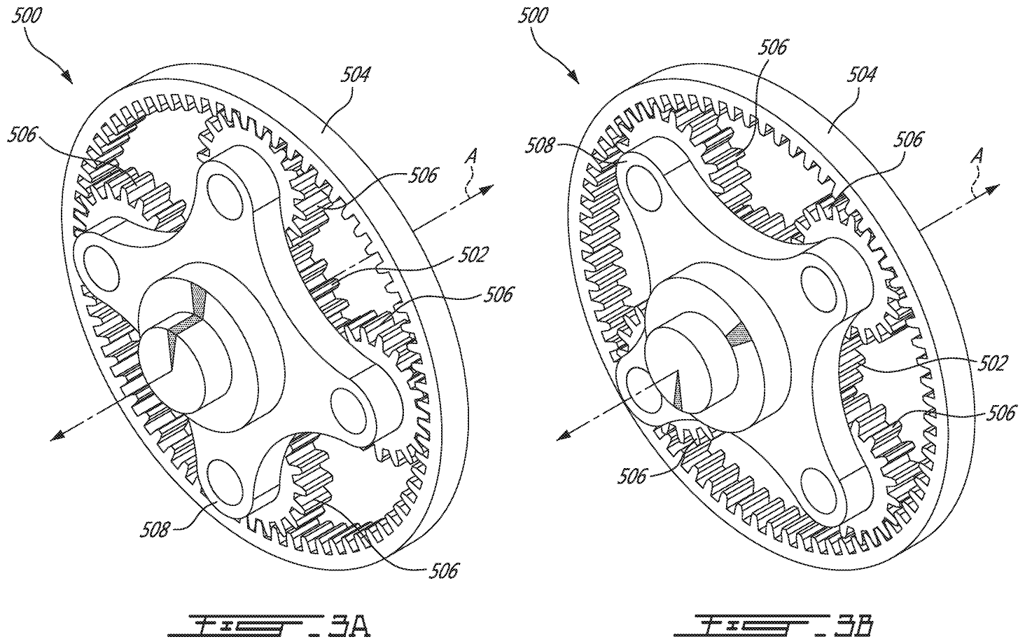

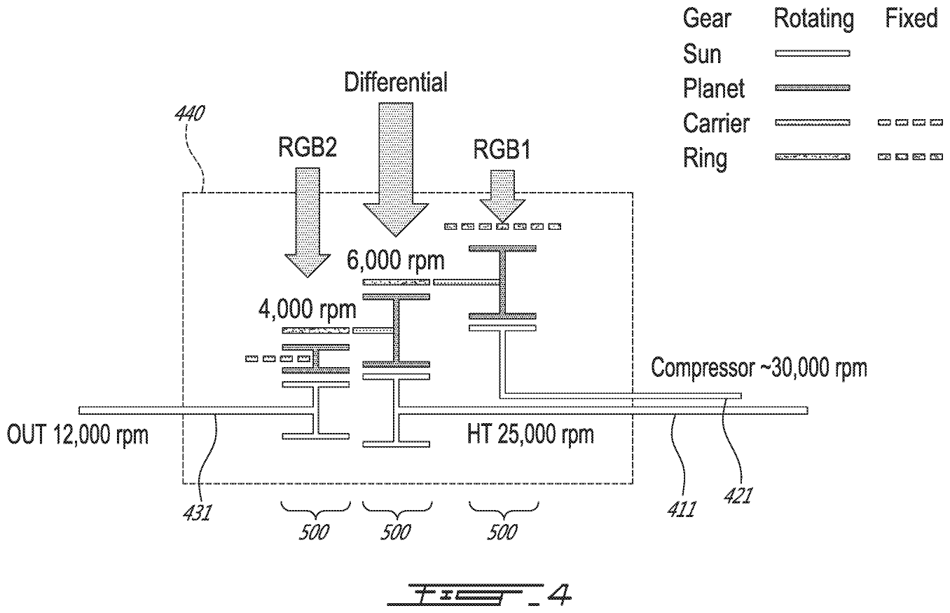

FIG. 3A is a schematic of a planetary gear set 500 of differential gearbox 440 of APU 400 in a first position, in accordance with an embodiment. FIG. 3B is a schematic of planetary gear set 500 of FIG. 3A in a second position.

Planetary gear set 500 includes four components: a sun gear 502 located in the center, a ring gear 504 that is the outer annulus gear, planet gears 506 connecting the outside of sun gear 502 to the inside of ring gear 504, and a carrier 508 that connects planet gears 506 at their centers of rotation. Sun gear 502, ring gear 504 and carrier 508 all rotate about center of axis A of planetary gear set 500.

In the second position illustrated in FIG. 3B, carrier 508 is rotated 45 degrees clockwise and ring gear 504 is held fixed as compared to the first position illustrated in FIG. 3A.

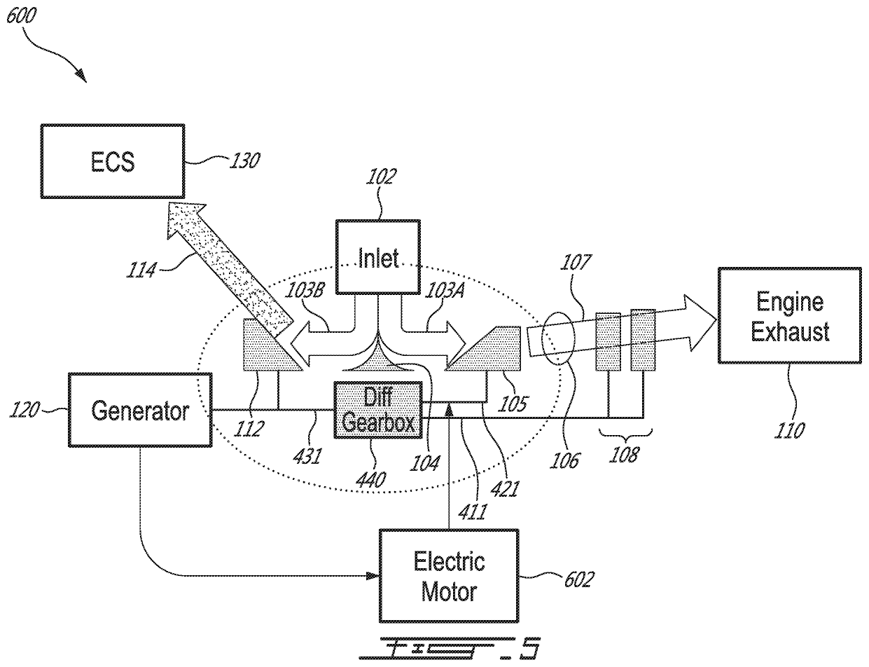

In some embodiments, differential gearbox 440 may include three planetary gear sets 500, interconnected as shown schematically in FIG. 4. Turbine shaft 411 may be connected to a sun gear 502 of a first planetary gear set 500 (labeled “Differential” in FIG. 4), compressor shaft 421 may be connected to a sun gear 502 of a second planetary gear set 500 (labeled “RGB1” in FIG. 4), and load shaft 431 may be connected to a sun gear 502 of a third planetary gear set 500 (labeled “RGB2” in FIG. 4). In some embodiments, compressor shaft 421 may be connected to a ring gear 504 of a second planetary gear set 500 or a carrier 508 of a second planetary gear set 500, depending on the speed of the component(s) driven by compressor shaft 421. In some embodiments, load shaft 431 may be connected to a ring gear 504 of a third planetary gear set 500 or a carrier 508 of a third planetary gear set 500, depending on the speed of the component(s) driven by load shaft 431. “RGB1” and “RGB2” may operate as a reduction gear set. Reduction gears such as “RGB1” and “RGB2” may be fixed and may be used to scale up or down the rotational speed (revolutions per minute) that are output from the “Differential” gear set. In some embodiments, reduction gear sets or gearboxes may or may not be integral with “Differential” or disposed within differential gearbox 440, or may be disposed in a separate location from the differential gear set or differential gearbox. In some embodiments, reduction gear sets or gearboxes may or may not be present. Reduction gear sets may or may not be planetary gear sets. While differential gearbox 440 is presented with three planetary gear sets 500, it will be understood that a differential gearbox with any suitable number of gear sets may be used. In some embodiments, two to four planetary gear sets are included in a differential gearbox such as differential gearbox 440.

FIG. 4 illustrates the interconnection between carrier 508 of “RGB1” and ring gear 504 of “Differential”, and the interconnection between carrier 508 of “Differential” and ring gear 504 of “RGB2”. As noted in FIG. 4, ring gear 504 of “RGB1” and carrier 508 of “RGB2” are fixed. The remaining components rotate.

In an example as shown in FIG. 4, with appropriate gear ratios, one or more turbines of turbine section 108 may rotate turbine shaft 411 and sun gear 502 of “Differential” at 25,000 rpm, rotating ring gear 504 of “Differential” at 6,000 rpm, and thus rotating carrier 508 of “RGB1” at 6,000 rpm. Carrier 508 of “Differential” rotates at 4,000 rpm, thus rotating ring gear 504 of “RGB2” at 4,000 rpm. Reduction gear “RGB1” thereby rotates its sun gear 502 and thus compressor shaft 421 at 30,000 rpm, and reduction gear “RBG2” thereby rotates its sun gear 502 and thus load shaft 431 at 12,000 rpm. These speeds are provided for reference, and may not specifically refer to a particular design. Other suitable speed ranges may be contemplated.

Differential gearbox 440 may thus split power and torque between shafts (for example, turbine shaft 411, compressor shaft 421 and load shaft 431). Unlike a standard gear set that transfers power and reduces torque in a linear fashion, differential gearbox 440 may split power between shafts (for example, turbine shaft 411, compressor shaft 421 and load shaft 431) based on speed and gear ratio of sun gear(s) 502 and ring gear(s) 504 of gears 500 in differential gearbox 440. Differential gearbox 440 may thus split torque between output shafts at a constant ratio that may be determined by a gear ratio such as the ratio of the sun gear to the ring gear, for example, in the “Differential” gear of FIG. 4. In some embodiments, turbine shaft 411, compressor shaft 421 and load shaft 431 may be interchanged between the gears described herein, depending on power split requirements. In an example, load shaft 431 may not run off carrier 508 of “Differential”, and compressor shaft 421 may not run off ring gear 504 of “Differential”.

APU 400 may thus be able to maintain a substantially constant output shaft speed on load shaft 431 (in an example, 12,000 rpm), while increasing or decreasing compressor shaft 421 and turbine shaft 411 speeds as output power increases or decreases. Allowing compressor shaft 421 and turbine shaft 411 speeds to vary may allow each component to operate at a more effective region of its operating range, and may make APU 400 more efficient. In an example, a substantially constant operating speed may be maintained at generator 120 while varying an operating speed of turbine section 108. Similarly, a substantially constant operating speed of load compressor 112 may be maintained while varying an operating speed of turbine section 108.

In some embodiments, differential gearbox 440 may maintain a substantially constant speed on output shaft 431, managed by the control of engine power and loading of load compressor 112 and HPC 105.

In some embodiments, differential gearbox 440 may include as few as one planetary (the “differential”) with standard reduction gears on from one to three input/output shafts. In some embodiments, differential gearbox 440 may include three additional epicyclic gear sets (four total) with or without additional RGBs. In some embodiments, differential gearbox 440 may include any other suitable combination of epicyclic and reduction gear sets.

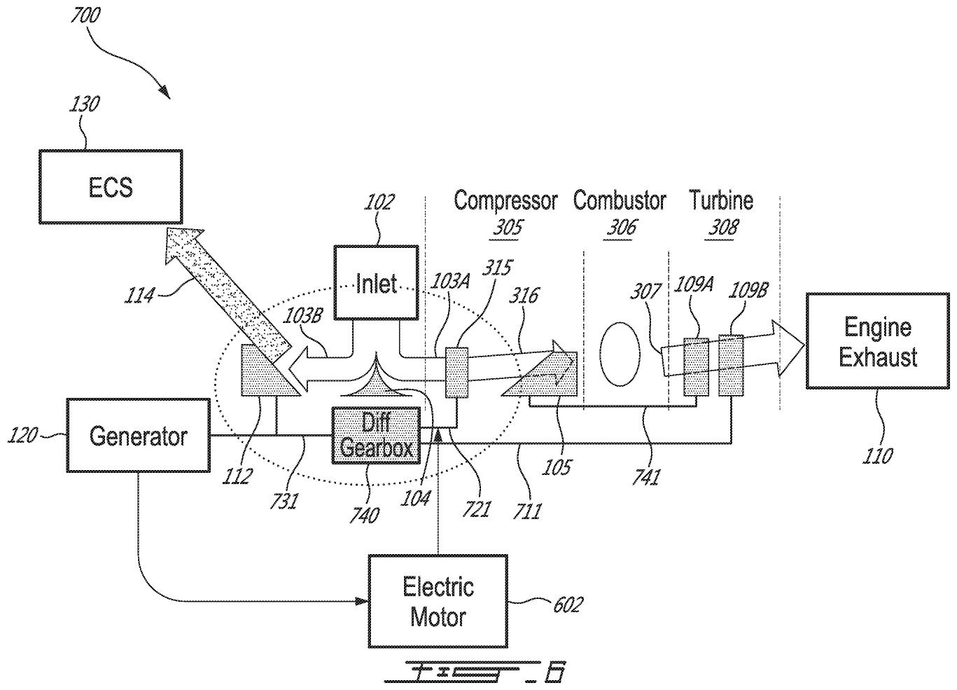

FIG. 5 illustrates an auxiliary power unit (APU) 600 including a gas turbine engine for use on an aircraft to supply electric and pneumatic power to the aircraft systems as an auxiliary or secondary source of power, in which components are connected through a differential gearbox. The differential gearbox can be configured to apportion an input torque between a first output torque and a second output torque.

Any other suitable engine may be employed.

As shown in FIG. 5, APU 600 includes some of the same structure and components as the architecture of APU 400, including inlet 102, flow splitter 104, engine stream air 103A, load stream air 103B, an engine compressor such as HPC 105, combustor 106, combustion stream 107, turbine section 108, engine exhaust 110, LDC 112, load compressor air 114, generator 120, ECS 130, and differential gearbox 440 as described herein.

APU 600 similarly includes turbine shaft 411, compressor shaft 421 and load shaft 431. Turbine shaft 411 connects to one or more turbines of turbine section 108. Compressor shaft 421 connects to HPC 105. Load shaft 431 connects to LDC 112 and generator 120. Turbine shaft 411, compressor shaft 421 and load shaft 431 are connected to differential gearbox 440.

APU 600 may also include an electric motor 602, driven by electric energy from generator 120 and operatively coupled to compressor shaft 421 to drive HPC 105. Thus, electric motor 602 may be used to supply additional torque to HPC 105.

In some embodiments, electric motor 602 is an AC motor, for example, an induction motor or an asynchronous motor, driven from an AC current source, such as three-phase, 400 Hz AC current produced by generator 120.

In some embodiments, electric motor 602 is a DC motor, driven by a DC current source, such as DC current supplied by generator 120, or supplied by, for example, a battery, accumulator, or external power source, such as a ground power unit, or DC current supplied by a suitable rectifier, such as a transformer rectifier unit, to convert AC current generated by generator 120 to DC, for example, 28 V DC current. In some embodiments, electric motor 602 is a starter motor, which may be a DC electric motor, and used to perform a starting function of the APU.

Electric motor 602 may be connected to compressor shaft 421 by way of a gearing configuration (not shown). An output shaft of electric motor 602 may be directly geared to compressor shaft 421, in an example, by way of a spur gear, to transfer rotational energy from electric motor 602 to compressor shaft 421.

In some embodiments, a clutch (not shown) operably connects electric motor 602 to compressor shaft 421 when engaged. When the clutch is engaged, rotational energy is transferred from electric motor 602 to compressor shaft 421. The clutch may be powered and controlled in a suitable manner.

In some embodiments, a control unit (not shown) may be used to control input power to electric motor 602, and thus output torque from electric motor 602. In some embodiments, operation of generator 120 may be controlled to maintain a desired (substantially constant) speed of LDC 112, and may thus affect electric energy generated by generator 120 and used to drive electric motor 602.

A constant rotational speed may be required on load shaft 431 connected to LDC 112 and generator 120, and torque may be increased at generator 120 and reduced at LDC 112. Thus, electric motor 602 may draw power from generator 120, thereby unloading LDC 112, and providing that power to HPC 105 by way of compressor shaft 421.

Conveniently, unloading LDC 112 may reduce the amount of pressurized load compressor air 114 that is generated and dumped overboard (at potentially a 100% loss of energy) and may improve the overall performance of APU 600.

Even in the event of substantial mechanical-electrical-mechanical conversion loss, drawing power from generator 120 to drive HPC 105 with electric motor 602 may provide a net benefit to the efficiency of APU 600 as compared to conventional techniques of dumping excess load compressor air 114.

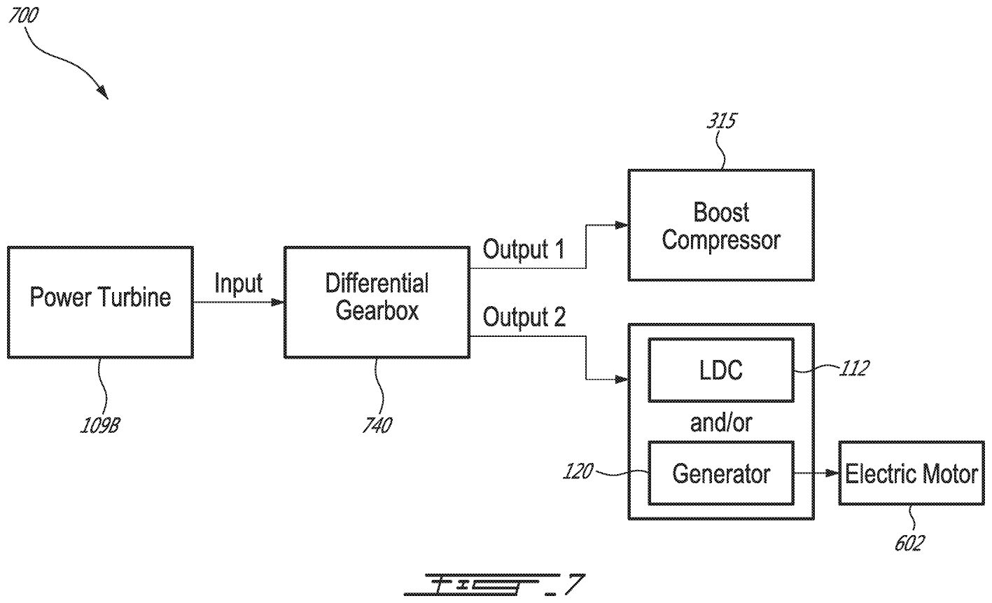

FIG. 6 illustrates an auxiliary power unit (APU) 700 including a gas turbine engine for use on an aircraft to supply electric and pneumatic power to the aircraft systems as an auxiliary or secondary source of power, in which components are connected through a differential gearbox. Any other suitable engine may be employed.

As shown in FIG. 6, APU 700 includes some of the same structure and components as the architecture of APU 100, including inlet 102, flow splitter 104, engine stream air 103A, load stream air 103B, an engine compressor such as HPC 105, engine exhaust 110, load compressor 112, load compressor air 114, generator 120 and ECS 130, as described herein.

APU 700 further includes compressor section 305 for pressurizing the engine stream air 103A by way of first engine compressor such as a boost compressor 315, forming boosted compressor stream 316 for further compression by a second engine compressor such as HPC 105 operatively disposed downstream from boost compressor 315 to form further compressed air and then fed to combustor section 306. Combustor section 306 may include, for example, combustor 106, and compressed air is mixed with fuel and ignited for generating an annular combustion stream 307 of hot combustion gases. Turbine section 308 has high-pressure turbine 109A and power turbine 109B for extracting energy from the combustion gases which then exhaust to engine exhaust 110. In some embodiments, turbines 109A, 109B may each be single-stage or multi-stage.

Compressor section 305, combustor section 306 and turbine section 308 are in serial flow communication and form part of the gas turbine engine, of which HPC 105, combustor section 306 and high-pressure turbine 109A form an engine core. The gas turbine engine defines a gas path through which gases flow, such as engine stream air 103A, boosted compressor stream 316 and combustion stream 307.

APU 700 further includes LDC 112 for pressurizing load stream air 103B to generate load compressor air 114 for use by ECS 130. In some embodiments, APU 700 may not include a load compressor such as LDC 112.

APU 700 may include a turbine shaft 711, a boost compressor shaft 721, a load shaft 731 and an engine core shaft 741. Turbine shaft 711 connects to power turbine 109B of turbine section 308. Boost compressor shaft 721 connects to boost compressor 315. Load shaft 731 connects to LDC 112 and generator 120. In some embodiments, APU 700 may not include a generator such as generator 120.

As shown in FIG. 6, turbine shaft 711, and engine core shaft 741 may be mechanically uncoupled, for example, in a dual spool configuration having a high-pressure spool and a low-pressure spool, and therefore may permit separate rotation. Thus, HPC 105 and high-pressure turbine 109A may be mechanically uncoupled from power turbine 109B, and therefore may permit separate rotation.

Turbine shaft 711, boost compressor shaft 721 and load shaft 731 are connected to a differential gear train, such as a differential gearbox 740. In some embodiments, differential gearbox 740 may have similar or the same structure and components as differential gearbox 440, or other suitable differential gearbox. Differential gearbox 740 may differ from differential gearbox 440 by having input from power turbine 1096 by way of turbine shaft 711 instead of one or more turbines of turbine section 108 connected to a turbine shaft 411 as shown in FIG. 5, and output to boost compressor 315 by way of boost compressor shaft 721 instead of HPC 105 connected to compressor shaft 421 as shown in FIG. 5.

In some embodiments, differential gearbox 740 may maintain a substantially constant speed on output shaft 731, managed by the control of engine power and loading of load compressor 112 and boost compressor 315.

The gas turbine engine of APU 700 may have a dual-spool configuration but it is understood that the gas turbine engine may not be limited to such configuration.

As illustrated in FIG. 6, APU 700 may further include electric motor 602, as described herein, driven by electric energy from generator 120 and differing from the configuration of APU 600 by being operatively coupled to boost compressor shaft 721 to drive boost compressor 315, instead of operatively coupled to compressor shaft 421 to drive HPC 105 as shown in FIG. 5. Thus, electric motor 602 may be used to supply additional torque to boost compressor 315.

Electric motor 602 may be connected to boost compressor shaft 721 by way of a gearing configuration (not shown). An output shaft of electric motor 602 may be directly geared to boost compressor shaft 721, in an example, by way of a spur gear.

In some embodiments, a clutch (not shown) operably connects electric motor 602 to boost compressor shaft 721 when engaged. When the clutch is engaged, rotational energy is transferred from electric motor 602 to boost compressor shaft 721. The clutch may be powered and controlled in a suitable manner.

In some embodiments, a control unit (not shown) may be used to control input power to electric motor 602, and thus output torque from electric motor 602. In some embodiments, operation of generator 120 may be controlled to maintain a desired (substantially constant) speed of LDC 112, and may thus affect electric energy generated by generator 120 and used to drive electric motor 602.

In some embodiments, APU 700 may include a starter motor operatively coupled to engine core shaft 741, and electric motor 602 is a second electric motor operatively coupled to boost compressor shaft 721.

A constant rotational speed may be required on load shaft 731 connected to LDC 112 and generator 120, and torque may be increased at generator 120 and reduced at LDC 112. Thus, electric motor 602 may draw power from generator 120, thereby unloading LDC 112, and providing that power to boost compressor 315 by way of boost compressor shaft 721.

Conveniently, unloading LDC 112 may reduce the amount of pressurized load compressor air 114 that is generated and dumped overboard (at potentially a 100% loss of energy) and may improve the overall performance of APU 700.

Even in the event of substantial mechanical-electrical-mechanical conversion loss, drawing power from generator 120 to drive boost compressor 315 with electric motor 602 may provide a net benefit to the efficiency of APU 700 as compared to conventional techniques of dumping excess load compressor air 114.

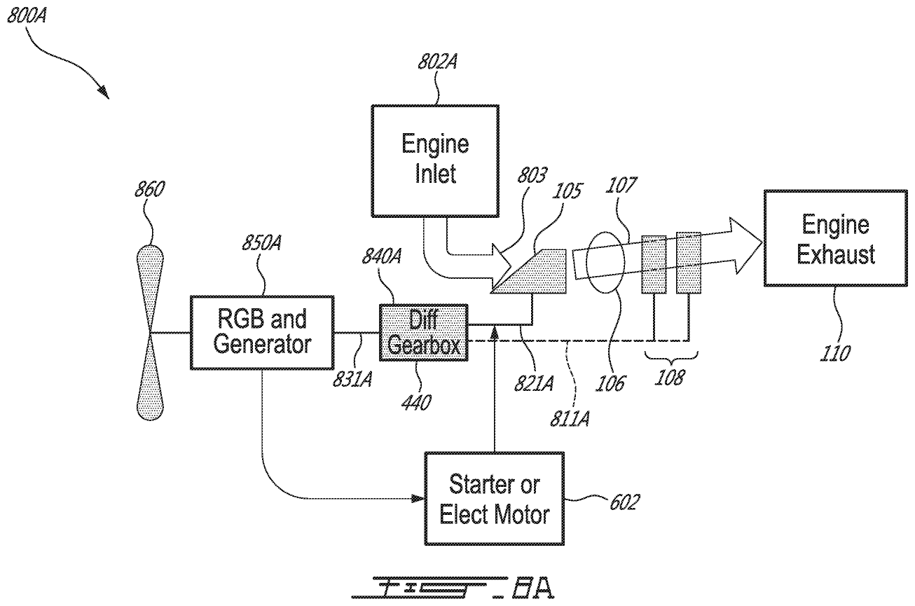

FIG. 7 is a schematic diagram of the operating environment of differential gearbox 740 in APU 700. As seen in FIG. 7, Input of torque to differential gearbox 740 may be from the rotation of power turbine 1096, for example, by way of turbine shaft 711. Output 1 of torque from differential gearbox 740 may rotate boost compressor 315, for example, by way of boost compressor shaft 721. Output 2 of torque from differential gearbox 740 may rotate LDC 112 and/or generator 120, for example, by way of load shaft 731. Electric energy produced by generator 120 is supplied to electric motor 602.

Optionally, Input, Output 1 and Output 2 from differential gearbox 740 may be passed through reduction gears (for example, “RGB1” and “RBG2” as shown in FIG. 6) to scale each of the outputs to a desired revolutions per minute to transfer to boost compressor 315, for example, by way of boost compressor shaft 721, and LDC 112 and generator 120, for example, by way of load shaft 731.

Returning to FIG. 6, engine core shaft 741 connects HPC 105 with high-pressure turbine 109A.

The component configuration shown in FIG. 6, in particular the use of differential gearbox 740, may allow boost compressor shaft 721, load shaft 731 and engine core shaft 741 to rotate at more effective speeds.

Load shaft 731 may rotate at a fixed speed, while boost compressor shaft 721 and engine core shaft 741 may rotate at faster speed (for example, upon an increase in required power on load shaft 731 by LDC 112 and/or generator 120) and may rotate at variable speeds in relation to each other.

Allowing the speed of boost compressor shaft 721 to vary as the required power of LDC 112 and generator 120 varies may optimize boost compressor 315 and may allow boost compressor 315 to operate without the need for expensive variable geometry (inlet guide vanes) and handling bleed valves.

The power demand of LDC 112 and generator 120 may drive the boost provided by boost compressor 315. As power required by LDC 112 or generator 120 increases, boost compressor 315 may speed up to operate APU 700 at a higher power. As power required by LDC 112 or generator 120 decreases, then the speed of boost compressor 315 may reduce. Thus, boost compressor 315 may provide as much pressure as needed. Differential gearbox 740 and the separation of boost compressor shaft 721 from turbine shaft 711 allows boost compressor 315 to have a different speed than power turbine 109B. Operation of boost compressor 315 may be further complemented by additional torque provided by electric motor 602.

Separating the rotation of HPC 105 and high-pressure turbine 109A (connected by engine core shaft 741) from power turbine 109B (connected to differential gearbox 740 by turbine shaft 711), in combination with electric motor 602 (drawing power from generator 120 and providing that power to boost compressor 315 by way of boost compressor shaft 721) may allow for a desired pressure ratio and allow APU 700 to operate at an efficient level.

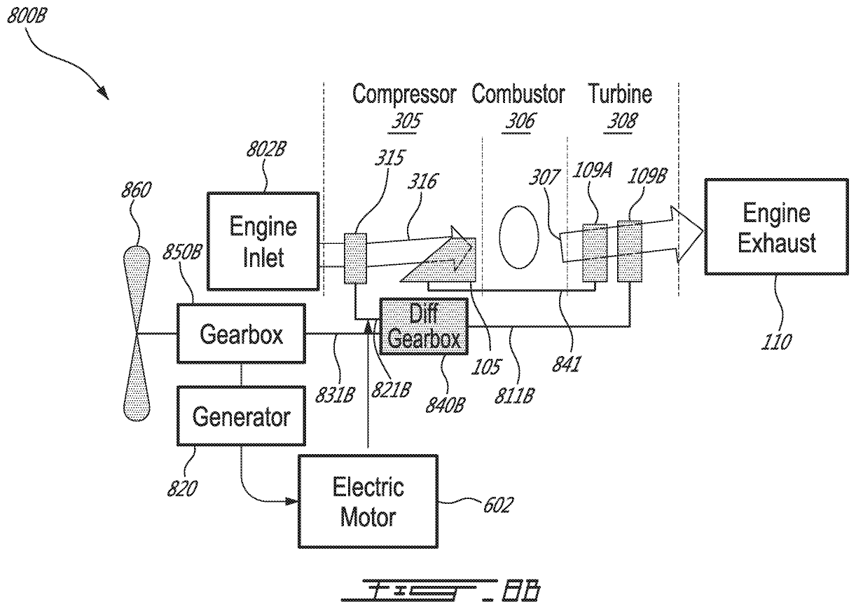

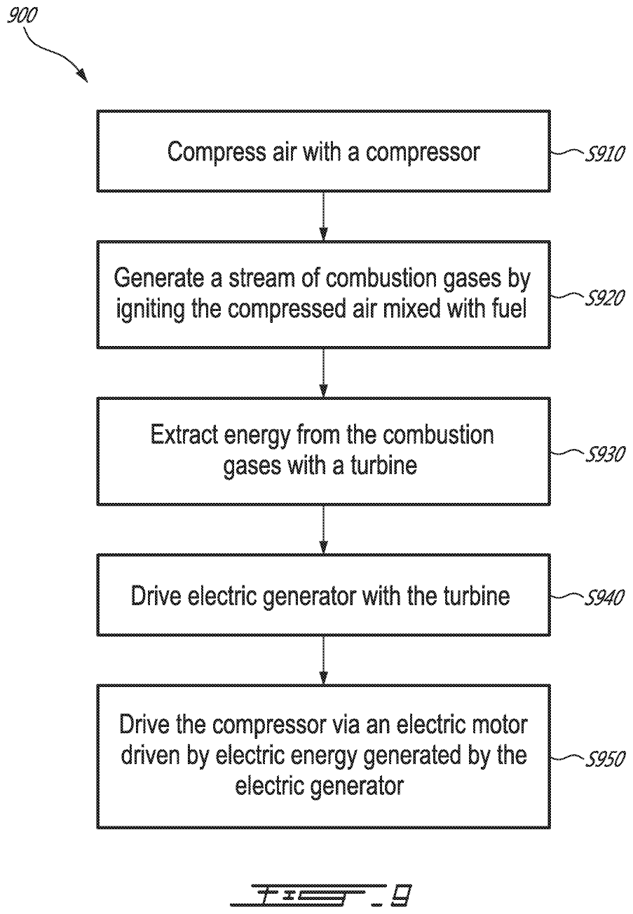

FIG. 8A illustrates a turboprop (or turboshaft) engine 800A, in accordance with an embodiment. Turboprop engine 800A may include some of the same structure and components as the architecture of APU 600, as described herein.

Ambient air is drawn into turboprop engine 800A by way of engine inlet 802A, forming engine stream air 803 which is then pressurized by HPC 105 and fed to combustor 106, in which compressed engine stream air 803 is mixed with fuel and ignited for generating an annular combustion stream 107 of hot combustion gases. Turbine section 108 has turbines, for example, a two-stage turbine as shown in FIG. 8A or other single stage or multi-stage turbine, for extracting energy from the combustion gases which then exhaust to engine exhaust 110.

HPC 105, combustor 106 and turbine section 108 form part of an engine core. Turboprop engine 800A defines a gas path through which gases flow, such as intake air from engine inlet 802A and annular combustion stream 107, to drive the engine.

Turboprop engine 800A may include a turbine shaft 811A, a compressor shaft 821A, and an output shaft 831A. Turbine shaft 811A is driven by one or more turbines of turbine section 108. Compressor shaft 821A connects to HPC 105. Output shaft 831A may replace load shaft 431, connecting to a propeller or shaft 860 by way of a (e.g., speed reduction) gearbox such as RGB and generator 850A.

Turbine shaft 811A, compressor shaft 821A and output shaft 831A are connected to a differential gear train, such as a differential gearbox 840A. In some embodiments, differential gearbox 840A may have similar or the same structure and components as differential gearbox 440, or other suitable differential gearbox.

RGB and generator 850A may be a combined reduction gearbox and electrical generator to generate electricity. In some embodiments, the reduction gearbox is an epicyclic gearbox. In some embodiments, the reduction gearbox is a multishaft gearbox. The generator may be oil-cooled and include a gearbox for transferring power from the gearbox to electric power.

In some embodiments, an electric generator may be external and operatively connected to the gearbox.

In some embodiments, RGB and generator 850A includes a synchronous AC generator (sometimes referred to as an “alternator”), such as a permanent magnet generator.

In some embodiments, RGB and generator 850A may have a power rating of 120 kVA. In some embodiments, RGB and generator 850A generates AC current, for example, a three-phase, 400 Hz, 115 or 120 phase voltage output. In some embodiments, RGB and generator 850A generates DC current.

In some embodiments, the generator of RGB and generator 850A operates at a substantially constant operating speed. In an example, the generator of RGB and generator 850A may operate at a constant speed of approximately 12,000 rpm (revolutions per minute), plus or minus 500 rpm.

As illustrated in FIG. 8A, engine 800A may further include electric motor 602, as described herein, driven by electric energy from RGB and generator 850A and operatively coupled to compressor shaft 821A to drive HPC 105. Thus, electric motor 602 may be used to supply additional torque to HPC 105.

Electric motor 602 may be connected to compressor shaft 821A by way of a gearing configuration (not shown). An output shaft of electric motor 602 may be directly geared to compressor shaft 821A, in an example, by way of a spur gear.

As shown in FIG. 8A, electric motor 602 may be a starter motor on compressor shaft 821A.

In some embodiments, a clutch (not shown) operably connects electric motor 602 to compressor shaft 821A when engaged. When the clutch is engaged, rotational energy is transferred from electric motor 602 to compressor shaft 821A. The clutch may be powered and controlled in a suitable manner.

In some embodiments, a control unit (not shown) may be used to control input power to electric motor 602, and thus output torque from electric motor 602.

The component configuration shown in FIG. 8A, in particular the use of differential gearbox 840A and electric motor 602, may allow compressor shaft 821A and turbine shaft 811A to run at variable speeds, as compared to the speed of output shaft 831A.

Electric motor 602 may draw power from RGB and generator 850A, providing that power to HPC 105 by way of compressor shaft 821A, and may improve the efficiency of engine 800A.

FIG. 8B illustrates a turboprop (or turboshaft) engine 800B, in accordance with an embodiment. Turboprop engine 800B may include some of the same structure and components as the architecture of APU 700, as described herein.

Ambient air is drawn into turboprop engine 800B by way of engine inlet 802B, which is then pressurized by boost compressor 315. Boost compressor 315 generates a boosted compressor stream 316 for further compression by HPC 105 and then fed to combustor section 306. Combustor section 306 may include, for example, combustor 106, and compressed air is mixed with fuel and ignited for generating an annular combustion stream 307 of hot combustion gases. Turbine section 308 has high-pressure turbine 109A and power turbine 109B for extracting energy from the combustion gases which then exhaust to engine exhaust 110.

Compressor section 305, combustor section 306 and turbine section 308 form part of an engine core. Turboprop engine 800B defines a gas path through which gases flow, such as intake air from engine inlet 802B, boosted compressor stream 316 and combustion stream 307.

Turboprop engine 800B may include a turbine shaft 811B, a boost compressor shaft 821B, an output shaft 831B and a high-pressure shaft 841. Turbine shaft 811B connects to power turbine 109B of turbine section 308. Boost compressor shaft 821B connects to boost compressor 315. Output shaft 831B may replace load shaft 731, connecting to a propeller or shaft 860 by way of a (e.g., speed reduction) gearbox 850B.

Turbine shaft 811B, boost compressor shaft 821B and output shaft 831B are connected to a differential gear train, such as a differential gearbox 840B. In some embodiments, differential gearbox 840B may have similar or the same structure and components as differential gearbox 740, or other suitable differential gearbox.

High-pressure shaft 841 connects HPC 105 with high-pressure turbine 109A.

Gearbox 850B may be a reduction gearbox. In some embodiments, gearbox 850B is an epicyclic gearbox. In some embodiments, gearbox 850B is a multishaft gearbox.

An electric generator 820 is operatively connected to gearbox 850B to generate electricity. Generator 820 may be oil-cooled and include a gearbox for transferring power from gearbox 850B to electric power.

In some embodiments, a generator in place of generator 820 may be integral with gearbox 850B embodied as an accessory gearbox (AGB) or a reduction gearbox (RGB).

In some embodiments, generator 820 is a synchronous AC generator (sometimes referred to as an “alternator”), such as a permanent magnet generator.

In some embodiments, generator 820 may have a power rating of 120 kVA. In some embodiments, generator 820 generates AC current, for example, a three-phase, 400 Hz, 115 or 120 phase voltage output. In some embodiments, generator 820 generates DC current.

In some embodiments, generator 820 operates at a substantially constant operating speed. In an example, generator 820 may operate at a constant speed of approximately 12,000 rpm (revolutions per minute), plus or minus 500 rpm.

In some embodiments, generator 820 is driven by an accessory gearbox (not shown) driven by way of, for example, a radially extending driveshaft (not shown) from gearbox 850B.

As illustrated in FIG. 8B, engine 800B may further include electric motor 602, as described herein, driven by electric energy from generator 820B and operatively coupled to boost compressor shaft 821B to drive boost compressor 315. Thus, electric motor 602 may be used to supply additional torque to boost compressor 315.

Electric motor 602 may be connected to boost compressor shaft 821B by way of a gearing configuration (not shown). An output shaft of electric motor 602 may be directly geared to boost compressor shaft 821B, in an example, by way of a spur gear.

In some embodiments, a clutch (not shown) operably connects electric motor 602 to boost compressor shaft 821B when engaged. When the clutch is engaged, rotational energy is transferred from electric motor 602 to boost compressor shaft 821B. The clutch may be powered and controlled in a suitable manner.

In some embodiments, a control unit (not shown) may be used to control input power to electric motor 602, and thus output torque from electric motor 602.

In some embodiments, engine 800B may include a starter motor operatively coupled to high-pressure shaft 841, and electric motor 602 is a second electric motor operatively coupled to boost compressor shaft 821B.

The component configuration shown in FIG. 8B, in particular the use of differential gearbox 840B and electric motor 602, may allow boost compressor shaft 821B and turbine shaft 811B to run at variable speeds, as compared to the speed of output shaft 831B.

Variable boost speed (of boost compressor shaft 821B, and thus boost compressor 315) may allow for more optimal compressor running lines, without the need for inlet guide vanes or handling bleed valves.

The component configuration shown in FIG. 8B may further maintain speed on boost compressor shaft 821B for a quicker spin-up from low (or idle) power conditions to high power conditions, and thus may provide an operability improvement.

Conveniently, components of a gas turbine engine system as disclosed herein, such as APU 600, APU 700, engine 800A or engine 800B, may improve efficiency and temperature margins of operation of the respective engines at low power.

The components of a gas turbine engine system as disclosed herein, such as APU 600, APU 700, engine 800A or engine 800B, may be manufactured using conventional machining or casting, or other suitable additive manufacturing techniques such as 3D printing.

FIG. 9 is a flow diagram of an example method 900 for operating a gas turbine engine, such as APU 600, APU 700, engine 800A, or engine 800B. Method 900 may be performed using various components of a gas turbine engine system, as described herein.

At block S910, a compressor, such as HPC 105 and/or boost compressor 315, compresses air, for example engine stream air 103A from inlet 102 or intake air from engine inlet 802A or 802B.

At block S920, a stream of combustion gases, such as combustion stream 107 or combustion stream 307, is generated by igniting the compressed air mixed with fuel in a combustor, such as combustor 106 or combustor 305.

At block S930, energy is extracted from the combustion gases with a turbine, such as a turbine of turbine section 108 or high-pressure turbine 109A and power turbine 1096 of turbine section 308. The compressor may be driven by the turbine.

At block S940, an electric generator, such as generator 120 or generator 820, is driven with the turbine, for example, via a first output of a differential, such as differential gearbox 440, differential gearbox 740, differential gearbox 840A, or differential gearbox 840B that is drivingly coupled to the turbine.

In some embodiments, the electric generator is driven at a constant rotational speed.

At block S950, an electric motor, such as electric motor 602, that is driven by electric energy generated by the electric generator, such as generator 120 or generator 820, with in turn helps to drive the compressor, such as HPC 105 or boost compressor 315, by supplementing the torque provided by the turbine (which may be via a second output of the differential).

In some embodiments, the compressor, such as HPC 105 or boost compressor 315, is driven via a second output of the differential, such as differential gearbox 440, differential gearbox 740, differential gearbox 840A, or differential gearbox 840B.

In some embodiments, a load compressor, such as LDC 112, is driven via the first output of the differential, such as differential gearbox 440, differential gearbox 740, differential gearbox 840A, or differential gearbox 840B and is configured to generate compressed air, such as load compressor air 114, for an environmental control system, such as ECS 130, of an aircraft, such as aircraft 10.

In some embodiments, the load compressor is driven at a constant rotational speed.

In some embodiments, a propeller, such as propeller 860, is driven via the first output of the differential, such as differential gearbox 840A or 840B, and in some embodiments, by way of gearbox 850A or 850B, respectively.

It should be understood that one or more of the blocks may be performed in a different sequence or in an interleaved or iterative manner.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A gas turbine engine system, comprising:
an engine compressor, a combustor, and a turbine in serial flow communication;
an electric generator configured to be driven by the turbine; and
an electric motor configured to be driven by electric energy generated by the electric generator, the electric motor configured in use to drive the engine compressor.

2. The system of claim 1, comprising a differential gear train having an input drivingly coupled to the turbine and a first output, the electric generator being drivingly coupled to the first output of the differential gear train.

3. The system of claim 2, wherein the first output is drivingly coupled to a load compressor configured to generate compressed air for an environmental control system of an aircraft.

4. The system of claim 2, wherein the differential gear train has a second output that is drivingly coupled to the engine compressor.

5. The system of claim 1, wherein the engine compressor is a first engine compressor, and the system includes a second engine compressor operatively disposed downstream from the first engine compressor.

6. The system of claim 2, wherein the differential gear train includes an epicyclic gear set.

7. The system of claim 2, wherein the differential gear train includes a compound epicyclic gear set.

8. The system of claim 2, wherein the first output is drivingly coupled to a propeller.

9. A method of operating a gas turbine engine, comprising:
using an engine compressor to compress air;
generating a stream of combustion gases by igniting the compressed air mixed with fuel;
extracting energy from the combustion gases with a turbine;
driving an electric generator with the turbine to generate electric energy; and
driving the engine compressor using an electric motor driven by the electric energy generated by the electric generator.

10. The method of claim 9, comprising driving the electric generator via a first output of a differential gear train.

11. The method of claim 10, comprising driving the engine compressor via a second output of the differential gear train.

12. The method of claim 10, comprising generating compressed air for an environmental control system of an aircraft using a load compressor driven via the first output of the differential gear train.

13. The method of claim 12, comprising maintaining a substantially constant operating speed of the electric generator while varying an operating speed of the turbine.

14. The method of claim 12, comprising maintaining a substantially constant operating speed of the load compressor while varying an operating speed of the turbine.

15. The method of claim 12, comprising controlling the electric generator to maintain a desired operating speed of the load compressor.

16. The method of claim 10, comprising maintaining a substantially constant operating speed of the electric generator while varying an operating speed of the turbine.

17. An auxiliary power unit comprising:
an engine compressor, a combustor, and a turbine in serial flow communication;
a differential gear train having an input shaft drivingly coupled to the turbine, a first output shaft and a second output shaft, the differential gear train configured to apportion an input torque from the turbine between a first output torque applied to the first output shaft and a second output torque applied to the engine compressor via the second output shaft;
an electric generator drivingly coupled to the first output shaft of the differential; and
an electric motor configured to be driven by electric energy generated by the electric generator, the electric motor configured in use to drive the compressor.

18. The auxiliary power unit of claim 17, further comprising a load compressor drivingly coupled to the first output shaft of the differential gear train.

19. The auxiliary power unit of claim 17, wherein the engine compressor is a first engine compressor, and the auxiliary power unit includes a second engine compressor operatively disposed downstream from the first engine compressor.

20. The auxiliary power unit of claim 18, wherein the differential gear train includes an epicyclic gear set.
